(19) United States
(12) Patent Application Publication
(10) Pub. No.: US 2024/0273600 A1
(43) Pub. Date: Aug. 15, 2024

(54) METHOD AND SYSTEM FOR INCREASING THE EFFICIENCY OF AN AUTOMATED COOKING RESTAURANT BY OFFERING A NEW DISH

(71) Applicant: KITCHEN ROBOTICS LTD, Modiin (IL)

(72) Inventors: Yair Gordin, Modiin (IL); David Ben-David, Rehovot (IL)

(73) Assignee: KITCHEN ROBOTICS LTD, Modiin (IL)

(21) Appl. No.: 18/199,063

(22) Filed: May 18, 2023

Related U.S. Application Data
(63) Continuation-in-part of application No. 18/108,636, filed on Feb. 12, 2023.

(51) Int. Cl. G06Q 30/0601; G06F 16/22; G06Q 50/12

(52) U.S. Cl. CPC G06Q 30/0631; G06F 16/221; G06Q 50/12

(57) ABSTRACT

A novel technique for improving the efficiency of an automated cooking restaurant (ACR) is disclosed. The novel technique offers a new dish. Wherein the new dish can be prepared from leftovers of food ingredients. In order to offer a recipe to the new dish a table TBrr can be used. Each cell in the header row of TBrr may comprise the name of a food ingredient from the list of leftovers, its current amount and indication about its popularity and wherein each cell in the header column of TBrr comprises the name of a food ingredient from the list of leftovers, its current amount and indication about its popularity.

### CROSS-REFERENCE TO RELATED APPLICATIONS

This is a utility patent application being filed in the United States as a non-provisional application for patent under Title 35 U.S.C. § 100 et seq. and 37 C.F.R. § 1.53(b). Further, this application is related to the following concurrently filed United States non-provisional application for patent, which is incorporated herein by reference in its entirety: the application bearing the title of METHOD AND SYSTEM FOR INCREASING THE EFFICIENCY OF AN AUTOMATED COOKING RESTAURANT (ACR) BY OFFERING AN EXISTING DISH, identified by attorney docket number 11053.1090. This application is also being filed as a continuation-in-part (CIP) application of the United States patent application filed on Feb. 12, 23 and assigned Ser. No. 18/108,636, which application is incorporated herein by reference in its entirety.

### FIELD OF THE DISCLOSURE

The present disclosure relates to the field of an automated-cooking-restaurant (ACR) and more particularly the disclosure relates to a novel technique for improving the efficiency of the ACR by adapting the currently used menu to existing food ingredients.

### BACKGROUND

A common automated cooking restaurant (ACR) is configured to work with a library of menus. The menus can be changed daily. Each menu can comprise a plurality of dishes and each dish is associated with a recipe. Each recipe defines ingredients to be used for preparing that relevant dish. Thus, each menu is associated with a plurality of ingredients.

Some of the ingredients may be used in more than one course. Pasta may be used cold in certain dishes of salad and may be used hot in certain courses of Italian food, for example. Further, some of the courses are more popular than others. Hamburger with chips is more popular than Salmon fish with green salad, for example. In addition some of the ingredients might be allergens that may induce allergies to a client. In the following description and claims, the terms dish and course can be used interchangeably.

Currently, an operator of an ACR may obtain the menu of the day associated with a recipe of each dish. Accordingly, the operator may prepare a list of ingredients to be used today. In some occasions, the operator may receive the list of ingredients (Lol) from a chef that prepared the menu. In other occasions the operator may receive the Lol from the controller of the ACR. After having the Lol the operator may start the preparation stage. By using the Lol the operator may fill a first food-ingredient-cartridge (FIC) with the first ingredient that is written in the list and put the first FIC in an ingredients-collecting-zone (ICZ) that is associated with the ACR. Then the operator may update an ACR-managing module (AMM) about the location of the first FIC in the ICZ. Updating the AMM can be done via the human interface of the AMM. In some embodiments the AMM is configured to instruct the operator where to put the FIC.

Then the operator may move to the second ingredient in the list and fill a second FIC with the second ingredient, puts the second FIC in the ICZ and updating the AMM about the location of the second FIC in the ICZ. The operator may continue, in this process, until the last ingredient in the list. Thus, at the end of the preparation stage the ICZ comprises a plurality of FICs that contain the ingredients that are needed in order to prepare the dishes that appear in the menu of the day.

Furthermore, the operator may be instructed to prepare few extra FIC with popular ingredients. The extra FIC can be kept in appropriate conditions in order to be used in cases that those ingredients will be needed. Thus, at the end of the preparation stage the AMM is aware of the amount of the food ingredients that are ready to be used. In some embodiments the AMM get the information about the amount of each ingredient from the operator. In other example embodiments the ACR may be configured to weigh the FIC.

There are occasions, in which one or more food ingredients have been terminated before the end of the day or the end of the shift. Thus, dishes that include at least one of those food ingredients cannot be served. In addition, there are occasions in which at the end of the day the ACR remains with unused food ingredients. These leftovers can be stored or have to be thrown away. Along the present disclosure and the claims the terms leftovers, remains, and unused food ingredients may be used interchangeably.

Consequently, managing of the food ingredients is a key factor in automated food preparation processes. Performance and efficiency of an ACR is highly depended on factors such as consumption of food ingredient.

### BRIEF SUMMARY

The needs and the deficiencies that are described above are not intended to limit the scope of the inventive concepts of the present disclosure in any manner. The needs are presented for illustration only. The disclosure is directed to a novel technique for managing the ACR according to the leftovers of food ingredients.

An example embodiment of the disclosed technique is configured to respond to an indication, that one of the food-ingredients is terminated, by scanning the menu of the day looking for one or more dishes that comprise the relevant food-ingredient. The found dishes can be removed from the menu of the day. Next, an example of AMM can be configured to determine the amount of the remained food-ingredients of the dishes that have been removed from the menu of the day. The decision can be based on the amount of food-ingredients that were prepared during the preparation stage minus the amount of the food ingredients that were included in the removed dishes.

Next, the AMM can be configured to scan the plurality of menus that are stored in its associated one or more databases that are related to a similar type of restaurant as the current ACR. If currently the ACR delivers Italian food, then the AMM may scan only the menus of Italian restaurants. If currently the ACR delivers Chinese food, then the AMM may scan only the menus of Chinese restaurants, etc.

After collecting one or more menus of similar restaurants, an example of AMM may scan the recipes of the dishes that are included in the collected one or more menus looking for a dish that can be prepared from the leftovers of the food ingredients. This dish can be added to the menu of the day. In case that two or more dishes were found, an example of AMM may select the most popular dish and add it to the menu. Alternatively, the two or more dishes can be added to the menu of the day. It should be noted that along the descriptions and the claims the term leftover may include also indication about the amount of the leftover. The amount can be given in wright units, such as but not limited to grams or volume units such as but not limited to liters.

In case that none of the menus, of similar restaurants, comprises a dish that can be prepared from the leftovers food ingredients, then an example of the disclosed technique can be configured to offer a recipe of an artificial-intelligence-dish (AID). The recipe of the AID can be based on a set of rules and restrictions that are stored in one of the databases (DB) of the AMM. Each type of restaurant may have its own set of rules and restrictions. An Italian restaurant may have a first set of rules and restrictions, a Mexican restaurant may have a second set of rules and restrictions, etc.

In some example embodiments of the disclosed technique the set of rules and restrictions can be delivered by a chef of the restaurant. In other example embodiments of the disclosed technique, the set of rules and restrictions can be generated automatically by an example of AMM that can be configured to scan the plurality of recipes and to deliver set of rules and restrictions. Some example embodiments may start with set of rules and restrictions that were delivered by the chef and during the operation of the ACR this set of rules and restrictions can be amended by the AMM according to the behavior of the customers of that ACR.

An example of set of rules and restrictions, of a type of restaurant, can be embedded in a table (TBrr). Each line of the TBrr can be associated with a food ingredient and each column can be associated also with a food ingredient. The first row of TBrr can be referred as “header row” that display the column names. In a similar way the first column of TBrr can be referred as “header column” that display the row names. A cell in a junction of line “n” (Ln) and column “m” (Cm) may store information that is related to the ratios between the food ingredient that is associated with the line “n” and the food ingredient that is associated with the column “m”. The information can comprise whether the two ingredients can be associated, if yes than indication on the ratio between the two may also be written in the cell. “X” gram of ingredient “n” can be combined with “Y” gram of ingredient “m”.

In some example embodiments “X” and “Y” may define an interval of weight per each ingredient. In some example embodiments of the disclosed technique table TBrr may include an indication about the popularity of the food ingredient. The popularity can be expressed as the percentage of ordering courses, which includes the relevant food ingredient, out of the total amount of ordering courses during a sampling period. Such a process is disclosed in United States patent application filed on Feb. 12, 23 and assigned Ser. No. 18/108,636, which application is incorporated herein by reference in its entirety.

Other example embodiments of the disclosed technique may define few intervals of number of ordering and give a score to each interval. The interval above 70% may get a High (H) score. The interval between 40-70% may get a medium (M) score. The interval below 40% may be associated with a Low (L) score, for example. Other example embodiments of the disclosed technique may use 5 intervals, for example. In the below table TBrr three intervals are used “H”, “M”, and “L”.

In addition each cell in the “header row” of TBrr may also include the current amount of the food ingredient that is associated with that column. This value is reduced each time that the relevant ingredient is delivered by the amount that has been delivered. In addition each cell in the “header row” of TBrr may include indication about the popularity of that ingredient. In a similar way each cell in the “header column” of TBrr may also include the current amount of the food ingredient that is associated with that row. This value is reduced each time that the relevant ingredient is delivered by the amount that has been delivered. In addition each cell in the “column row” of TBrr may include indication about the popularity of that ingredient.

A portion of an example of TBrr for an Italian restaurant is illustrated below:

An example of TBrr

| | Spaghetti H, | Mozzarella M, | Lemon M | Tomato M | Garlic | Oregano L | Salami M | Olives M |
|---|---|---|---|---|---|---|---|---|
| | 0 gram | 200 gram | 100 cc | 500 gram | (50 teeth) L | (20 gram) | (150 gram) | (100 grams) |
| Spaghetti H, | | 220/20 | 0 | 220/50 | 220/2 | 220/2 | 220/20 | 220/10 |
| 0 gram | | | | | | | | |
| Mozzarella M, | 20/220 | 0 | 0 | 20/50 | 20/2 | 20/2 | 20/20 | 20/10 |
| 200 gram | | | | | | | | |
| Lemon M | 0 | 0 | 0 | 10/100 | 0 | 0 | 0 | 0 |
| 100 cc | | | | | | | | |
| Tomato M | 50/220 | 50/20 | 100/10 | 0 | 50/2 | 50/2 | 50/20 | 50/10 |
| 500 gram | | | | | | | | |
| Garlic | 2/220 | 0 | 0 | 0 | 0 | 0 | 0 | 0 |
| (50 teeth) L | | | | | | | | |
| Oregano L | 2/220 | 0 | 0 | 0 | 0 | 0 | 0 | 0 |
| (20 gram) | | | | | | | | |
| Salami M | 20/220 | 0 | 20/3 | 0 | 0 | 0 | 0 | 0 |
| (150 gram) | | | | | | | | |
| Olives M | 10/220 | 0 | 0 | 10/50 | 0 | 0 | 50/20 | 0 |
| (100 grams) | | | | | | | | |

An example of AMM can be configured to analyze the leftovers of food ingredients and organize them according to their cost. Then, the most expensive one can be selected and table TBrr can be search in order to conclude which an AID can be assembled from the leftovers. The process may take into consideration the popularity of each remained ingredient. In case that Mozzarella is the most expensive ingredient, then Tomato, olives and salami may be added in order to define a new AID such as “Salami on Mozzarella salad” or “Buffalo salad”.

Next, the cost of the AID can be defined. The cost can be defined based on the cost of each ingredient. Alternatively, the cost can be defined based on the cost of similar dishes in the menu. The cost of the “Buffalo salad” can be similar to the cost of “Caprese salad”. The new AID can be added to the top of the currently used menu as the “Special of the day”. Other example embodiments may ask the approval of the chef of the ACR before adding the new AID to the menu.

These and other aspects of the disclosure will be apparent in view of the attached figures and detailed description. The foregoing summary is not intended to summarize each potential embodiment or every aspect of the present invention, and other features and advantages of the present invention will become apparent upon reading the following detailed description of the embodiments with the accompanying drawings and appended claims.

Further, although specific embodiments are described in detail to illustrate the inventive concepts to a person skilled in the art, such embodiments can be modified to various modifications and alternative forms. Accordingly, the figures and written description are not intended to limit the scope of the inventive concepts in any manner.

Other objects, features, and advantages of the present invention will become apparent upon reading the following detailed description of the embodiments with the accompanying drawings and appended claims.

### BRIEF DESCRIPTION OF THE DRAWINGS

Some examples of embodiments of the present disclosure will be understood and appreciated more fully from the following detailed description, taken in conjunction with the drawings in which:

FIG. 1 schematically illustrates a block diagram with relevant elements of an example of an ACR-managing-module (AMM);

FIG. 2 illustrates a flowchart with relevant actions that can be implemented a Food-Ingredient-Tracker (FIT) module for tracking the consumption of food ingredient during ongoing operation of the ACR;

FIG. 3 illustrates a flowchart with relevant actions that can be implemented for generating an example of TBrr;

FIG. 4 illustrates a flowchart with relevant actions that can be implemented for finding an AID which is based on an existing dish; and

FIGS. 5A and 5B illustrate a flowchart with relevant actions that can be implemented for generating an AID which does not exist in any menu.

### DETAILED DESCRIPTION OF SOME EXAMPLE EMBODIMENTS

Turning now to the figures in which like numerals represent like elements throughout the several views, in which exemplary embodiments of the disclosed techniques are described. For convenience, only some elements of the same group may be labeled with numerals.

The purpose of the drawings is to describe examples of embodiments and not for production purpose. Therefore, features shown in the figures are chosen for convenience and clarity of presentation only. Moreover, the language used in this disclosure has been principally selected for readability and instructional purposes, and may not have been selected to define or limit the inventive subject matter, resort to the claims being necessary to determine such inventive subject matter.

In this specification, these implementations, or any other form that the invention may take, may be referred to as techniques. In general, the order of the steps of disclosed processes may be altered within the scope of the invention. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

In the following description and claims, the words “unit,” “element,” “module”, and “logical module” may be used interchangeably. Anything designated as a unit or module may be a stand-alone unit or a specialized or integrated module. A unit or a module may be modular or have modular aspects allowing it to be easily removed and replaced with another similar unit or module. In addition the terms element and section can be used interchangeably. In the following description and claims, the words “course,” “dish”, and “meal” may be used interchangeably

Each unit or module may be any one of, or any combination of, software, hardware, and/or firmware, ultimately resulting in one or more processors programmed to execute the functionality ascribed to the unit or module. Additionally, multiple modules of the same or different types may be implemented by a single processor. As used herein, the term ‘processor’ can refer to a computer such as but not limited to Intel NUC, wherein NUC stands for Next-Unit-of-Computing or “Amazon EC2 A1 Instances” or “Amazon EC2 P3 Instances”, which are maintained by Amazon Corp USA, for example. Other example embodiments of the disclosed technique may use cloud resources as processors, servers such as but not limited to AWS of Amazon Corp USA, non-transitory computer readable storage devices, etc.

Software of a logical module may be embodied on a computer readable device such as but not limited to a read/write solid-state disc (SSD), CDROM, Flash memory, ROM, or other non-transitory computer readable storage device, etc. In order to execute a certain task a software program may be loaded to an appropriate processor as needed. In the present disclosure the terms task, method, process can be used interchangeably. In the present disclosure the verbs transmit, transfer or be placed in a queue can be used interchangeably.

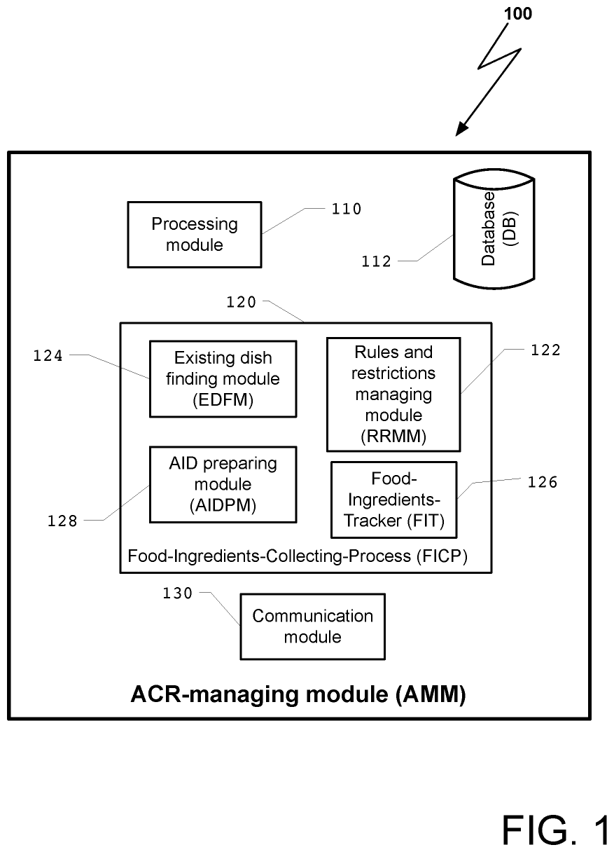

FIG. 1 schematically illustrates a block diagram with relevant elements of an example of an ACR-managing-module (AMM) 100. Example embodiments of AMM 100, among other tasks, are configured to increase the efficiency of an ACR by offering dishes that can be prepared from leftovers of food ingredients. AMM 100 may comprise a processing module 110, a non-transitory computer readable storage device, database 112, a Food-Ingredients-Collecting-Process (FICP) 120, and communication module 130. The communication module 130 handles the communication between the elements of AMM 100 and one or more ACRs and one or more clients and the communication with the operator workstation. The communication can be based on Internet Protocol (IP). Communication over an IP network is well known to a person having an ordinary skill in the art and will not be further disclosed. In some example embodiments of of the disclosed technique the processing module 110 and DB 112 may reside in a cloud-base-server (CBS). In such embodiment AMM can be embedded in a programmable logic controller (PLC). That is configured to communicate with a CBS.

Processing module 110 may comprise a non-transitory computer readable storage device and a processor. The processor can be a computer such as but not limited to Intel NUC, wherein NUC stands for Next-Unit-of-Computing or “Amazon EC2 A1 Instances” or “Amazon EC2 P3 Instances”, which are maintained by Amazon Corp USA, for example. Other example embodiments of the disclosed technique may use cloud resources as processors, servers, non-transitory computer readable storage devices, etc.

The non-transitory computer readable storage device may store programs, tables and data that are used during the operation of the processor. Database (DB) 112 may store data related to the different menus that are served by AMM 100. The data may comprise data that is related to ingredients that are used, properties of the different ingredients, setups (mapping) of FICs in an ingredients-collecting-zone (ICZ) for the current menu, etc. Further, in some example embodiments of the disclosed technique DB 112 may comprise table TBrr.

The FICP 120 can be a non-transitory computer readable storage device that may store software programs to be used in order to improve the utilization of the food ingredients and to increase the efficiency of the relevant ACR. The non-transitory computer readable storage device can be such as but not limited to a read/write hard disc, CDROM, Flash memory, ROM, etc. In some examples embodiments of the disclosed technique FICP 120 may comprise four logical modules: a rules-and-restrictions-managing-module (RRMM) 122, an existing-dish-finding-module (EDFM) 124, a food-ingredient-tracker (FIT) 126 and an artificial-intelligence-dish (AID) module (AIDPM) 128.

An example of RRMM 122 may store a software program that when is loaded to the processing module 110, the processing module 110 may start preparing a TBrr that is relevant to the menu of the day. Each line of the TBrr can be associated with a food ingredient that is related to the menu of the day and each column can be associated also with a food ingredient that is related to the menu of the day. A cell in a junction of line “n” (Ln) and column “m” (Cm) may store information that is related to the ratios between the food ingredient that is associated with the line “n” and the food ingredient that is associated with the column “m”. The information can comprise whether the two ingredients can be associated, if yes than indication on the ratio between the two may also be written in the cell. “X” gram of ingredient “n” can be combined with “Y” gram of ingredient “m”, for example.

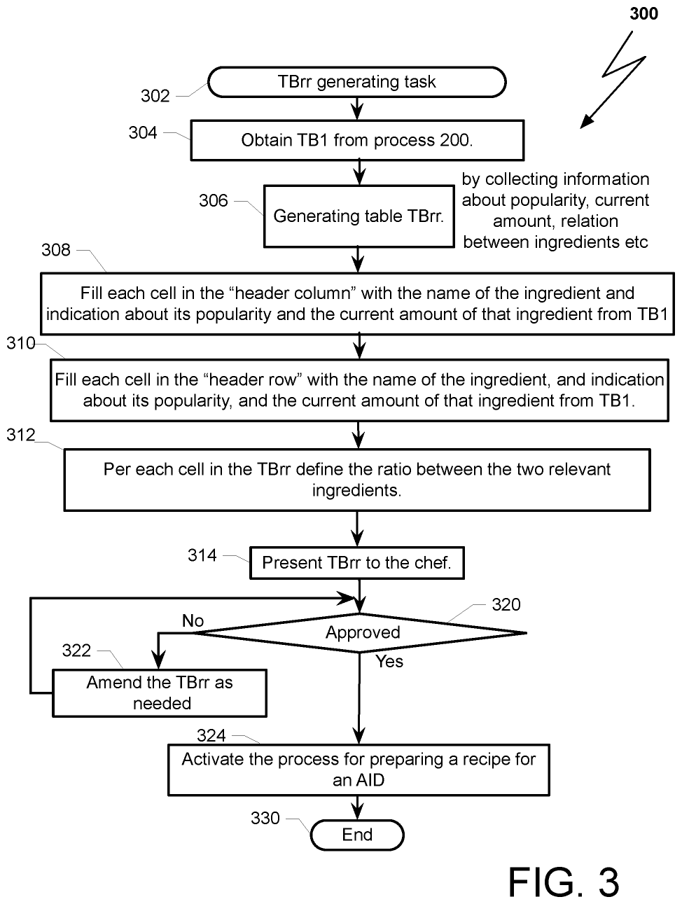

In addition each cell in the “header row” of TBrr may also include the current amount of the food ingredient that is associated with that column. This value is reduced each time that the relevant ingredient is delivered by the amount that has been delivered. In addition each cell in the “header row” of TBrr may include indication about the popularity of that ingredient. In a similar way each cell in the “header column” of TBrr may also include the current amount of the food ingredient that is associated with that row. This value is reduced each time that the relevant ingredient is delivered by the amount that has been delivered. In addition each cell in the “column row” of TBrr may include indication about the popularity of that ingredient. More information about the operation of RRMM 122 is disclosed below in conjunction with FIG. 3.

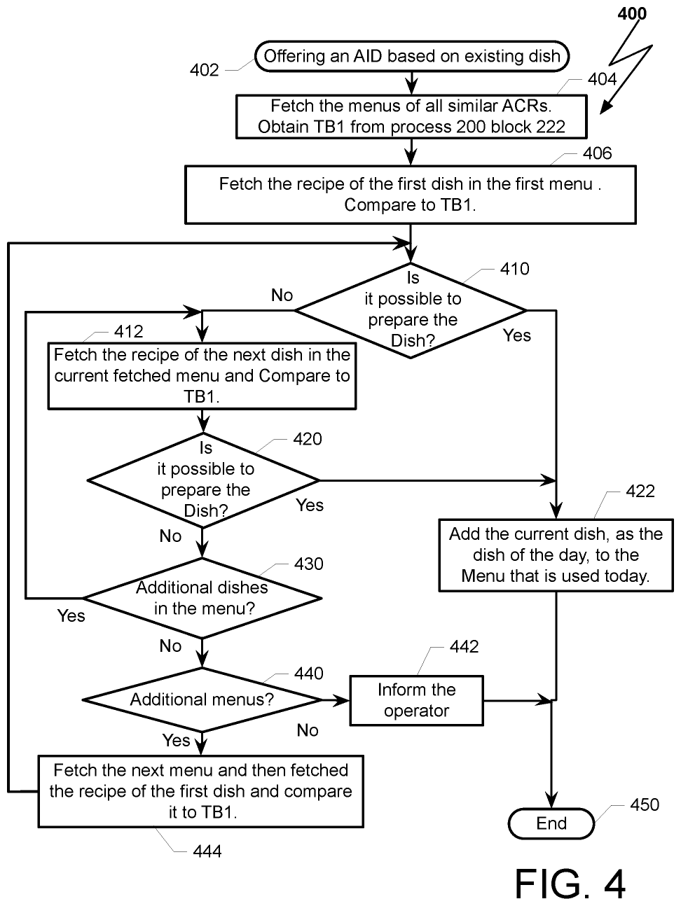

An example of EDFM 124 may store a software program that when is loaded to the processing module 110, the processing module 110 may start looking for an existing dish of a similar type of restaurant that can be prepared from the current leftovers food ingredients. If the menu of the day is Italian, then the EDFM 124 may scan only menus of Italian restaurants. If the menu of the day is Chinese menu, then EDFM 124 may scan only menus of Chinese restaurants, etc. More information about the operation of EDFM 124 is disclosed below in conjunction with FIG. 4.

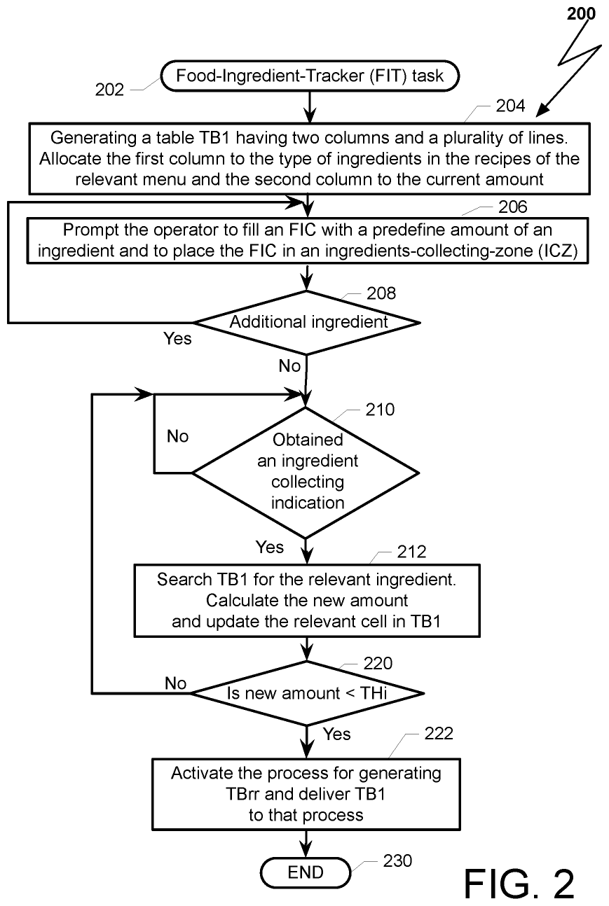

An example of FIT 126 may store a software program that when is loaded to the processing module 110, the processing module 110 may track the utilization of the food ingredients and may collect data that can be used in order to update TBrr to the current stat of the food ingredients. More information about the operation of FIT 126 is disclosed below in conjunction with FIG. 2.

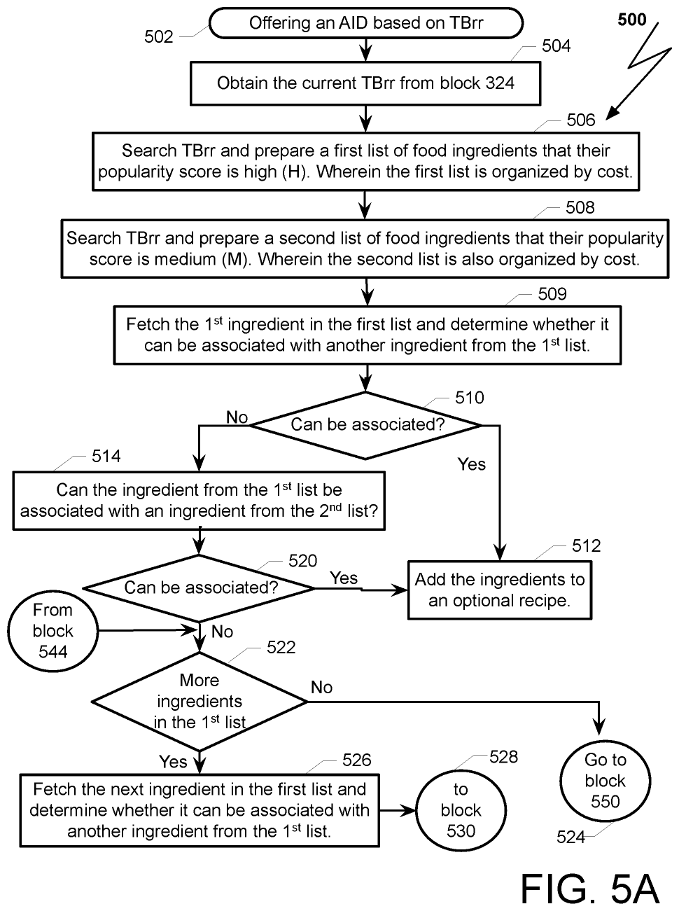

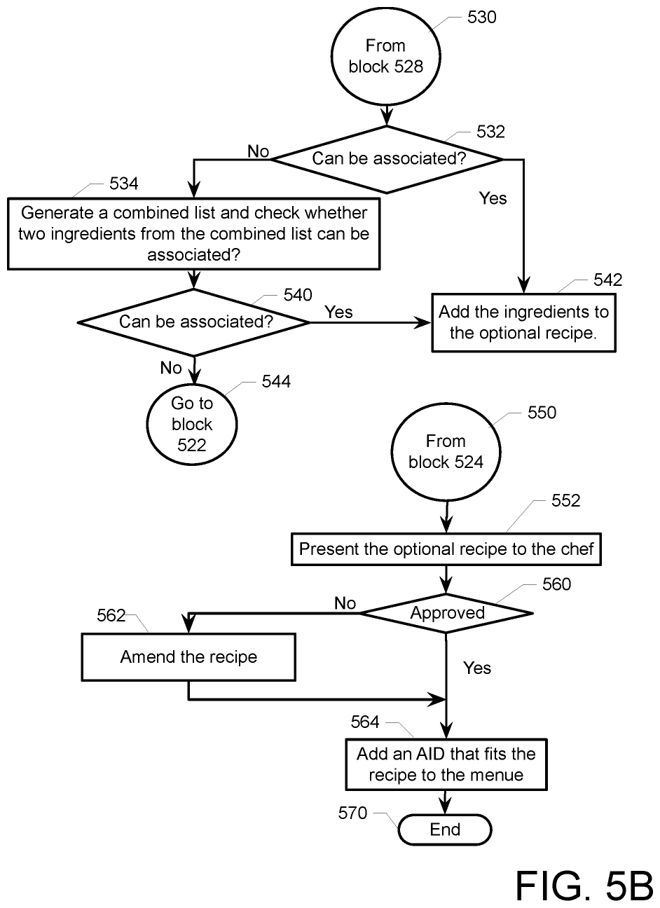

An example of AIDPM 128 may store a software program that when is loaded to the processing module 110, the processing module 110 may offer a recipe of a new dish that may fit a similar type of restaurant. The new dish can be prepared from the current leftovers and it does not appear in any of the menus that belong to the current ACR. More information about the operation of AIDPM 128 is disclosed below in conjunction with FIGS. 5A&B.

FIG. 2 illustrates a flowchart of a process 200 with relevant actions that can be implemented by an example embodiment of a Food-Ingredient-Tracker (FIT) module 126 (FIG. 1) for tracking the consumption of food ingredient during ongoing operation of the ACR. Process 200 can be initiated 202 by an operator in the beginning of a shift. In some cases the operator can be the chef that is associated with a certain ACR. After initiation, table TB1 can be generated 204. TB1 may have two columns and a plurality of lines. The first column can be allocated to the type of the ingredients that can be used in today menu and the second column can be allocated to the current amount of the relevant food ingredients. In some example embodiments of the disclosed technique TB1 may have a 3^{rd} column. The 3^{rd} column can be assigned to a threshold level of the relevant ingredient (THi) that below this level, the leftovers ingredients cannot be used and the FIC has to be replaced with a full one.

Next at block 206 process 200 may prompt the operator to fill an FIC with a predefine amount of a certain ingredient and to place the full FIC in a certain location in the ICZ. Then a decision is made 208 whether additional ingredient exist in TB1. If 208 yes, process 200 may return to block 206 and prompt the operator to handle the next ingredient. If 208 no, process 200 may proceed to block 210.

In other example embodiments of the disclosed technique block 206 can be modified. In such embodiment the operator may measure the amount of the food ingredient that is placed in the FIC and inform the FIT 126 (FIG. 1). Further, in some embodiments the operator may decide where to put the FIC in the ICZ and then inform the FIT 126.

At this point, the preparation stage is terminated while the FIT 126 is aware of the amount of the food ingredients in each FIC. Then, process 200 may wait 210 to get an indication that a food ingredient has been collected. The indication can be obtained from the ICZ and may include the type of the ingredient and the amount of the ingredients that has been collected. After obtaining the indication, FIT may search 212 TB1 looking for the line that is associated with that food ingredient. Then the value of the current amount can be updated by reducing the amount that was collected from the current mount in order to get the new amount.

Next, 220 a decision is made whether the new amount is smaller than the value of the threshold THi of that ingredient. In some embodiments, in which THi is not used, the new amount can be compared to zero. If 220 the new amount is not smaller, then process 200 may return to block 210 waiting to another collecting indication. If 220 the new amount is below THi, then process 200 may activate 222 RRMM 122 in order to prepare a TBrr. In addition a pointer to TB1 can be delivered to RRMM 122. Then process 200 can be terminated 230.

In some example embodiments of FIT 126 block 222 can be modified to activate EDFM 124 (FIG. 1) in order to search for an existing dish that can be prepared from the leftovers. In such embodiment a pointer to TB1 can be given to EDFM 124. Then process 200 can be terminated 230.

FIG. 3 illustrates a flowchart of a process 300 with relevant actions that can be implemented by an example of logical module rules-and-restrictions-managing-module (RRMM) 122 (FIG. 1) for generating an example of TBrr that is adapted to the current menu and the current leftovers. Process 300 can be initiated 302 at block 222 of process 200. After initiation 302 RRMM 122 may fetch 304 TB1 base on the pointer received from FIT 126 (FIG. 1) at action 222.

At block 306 table TBrr can be generated based on TB1 and a set of rules and restrictions that are related to the type of the restaurant (Italian restaurant, Mexican restaurant, etc.). The set of rules can be fetched from DB 112 (FIG. 1). Table TBrr may have a plurality of lines and columns. Then, each cell in the “header column” of TBrr can be filled 308 with the name of an ingredient from TB1 and the current amount of that ingredient. In addition, indication about the popularity of this ingredient can be fetched from DB 112 (FIG. 1) and be written in that cell. The popularity can be defined by scores, High (H), medium (M) and Low (L). Other embodiments may use other numbers of scores, five scores for example.

Next, each cell in the “header row” of TBrr can be filled 310 with the name of an ingredient from TB1 and the current amount of that ingredient. In addition, indication about the popularity of this ingredient can be fetched from DB 112 (FIG. 1) and be written in that cell. The popularity can be defined by scores, High (H), medium (M) and Low (L). Other embodiments may use other numbers of scores, five scores for example

At block 312 process 300 may define, per each cell of TBrr, the ratio between the two relevant ingredients. Thus, the cell in the junction of line “n” (Ln) and column “m” (Cm) may store information that is related to the ratio between the food ingredient that is associated with the line “n” and the food ingredient that is associated with the column “m”. This information can be fetched from DB 112 (FIG. 1) and may indicate whether the two ingredients (Ln & Cm) can be associated, if yes than indication on the ratio between the two may also be written 312 in that cell. “X” gram of ingredient “Ln” can be combined with “Y” gram of ingredient “Cm”, for example.

Next, table TBrr can be presented 314, via communication module 130 (FIG. 1) over a display of the workstation of the ACR to the chef in order to get his/her approval. If 320 the content of TBrr is not approved, then the chef, or the operator, is requested to amend 322 the table as needed and process returns to block 320. If 320 the content of TBrr is approved, then process 300 may activate 324 AIDPM 128 (FIG. 1) in order to prepare a recipe of an AID based on TBrr. In addition a pointer to TBrr can be delivered to AIDPM 128 and process 300 can be terminated 330.

Referring now to FIG. 4 that illustrates a flowchart with relevant actions of a process 400 that can be implemented by an example embodiment of EDFM 124 (FIG. 1) for finding an artificial-intelligence-dish (AID), which is based on an existing dish of a similar restaurant that appears in another menu then the menu of today. Process 400 can be initiated 402 by FIT 126 (FIG. 1) block 222 upon determining 220 (FIG. 2) that the new amount of at least one of the ingredient is below THi of that ingredient. THi can be zero or any other threshold in grams or liters.

After initiation EDFM 124 may fetch 404, from DB 112 (FIG. 1), the menus of all similar restaurants. If the current restaurant is an Italian restaurant, then all the Italian menus can be fetched from DB 112. In addition a copy of TB1 can be obtained from process 200 block 222 (FIG. 2). Next the recipe of the first dish in the first menu can be obtained 406 from DB 112 and the recipe can be compared to the leftovers that are written TB1.

Next a decision is made 410 whether that dish can be prepared from the leftovers. If 410 yes, then at block 422 the current dish can be added 422 to the menu that is used today as the dish of the day and process 400 can be terminated 450. If 410 it is not possible to prepare that dish from the leftovers, then the recipe of next dish, in that fetched menu, can be fetched 412 from DB 112 (FIG. 1) and be compared to the amount of the leftovers that are written in TB1. Then, a decision is made 420 whether that dish can be prepared from the leftovers. If 420 yes, then at block 422 the current dish can be added 422 to the menu that is used today as the dish of the day and process 400 can be terminated 450. If 420 it is not possible to prepare that dish from the leftovers, then a decision is made 430 whether additional dishes exist in that fetched menu.

If 430 yes, then process 400 may return to block 412. If 430 there is no additional dish in that fetched menu, then a decision can be made 440, whether additional menus, of a similar restaurant, exist in DB 112 (FIG. 1). If 440 yes, then the next menu can be fetched 444 and the recipe of the first dish in that menu can be fetched from DB 112 (FIG. 1) and be compared 444 to the amount of leftovers that are written in TB1.

If 440 there is no additional menu in DB 112, then the operator can be informed 442 that the leftovers cannot be used and process 400 can be terminated. In other example embodiments of process 400 instead of informing 442 the operator, process 400 can be configured to transfer 442 a pointer to TB1 to artificial-intelligence-dish (AID) module (AIDPM) 128 (FIG. 1) and let it to generate a new dish that is based on a new recipe that can be made from the leftovers. Next process 400 can be terminated 450.

FIGS. 5A and 5B illustrate a flowchart with relevant actions of process 500 that can be implemented by an example of artificial-intelligence-dish (AID) module (AIDPM) 128 (FIG. 1) for generating an AID from the leftovers, which does not exist in any menu of that ACR. Process 500 can be initiated 502 by RRMM 122 (FIG. 1) at block 324 of process 300 by activating AIDPM 128 (FIG. 1) in order to prepare a recipe of an AID based on the prepared TBrr. In addition a pointer to TBrr can be delivered to AIDPM 128.

Based on the obtained pointer, TBrr can be obtained 504 from DB 112 (FIG. 1). Then, process 500 may search 506, the obtained TBrr, for ingredients that their popularity score is high (H). Those ingredients can be copied to a first list. Next the cost of each of these ingredients can be fetched from DB 112 (FIG. 1) and the ingredients in the list can be organized according to their cost. The ingredient with the highest cost can be at the top of the list and the one with the lowest cost at the bottom of the first list.

Process 500 may continue and search 508 the obtained TBrr for ingredients that their popularity score is medium (M). Those ingredients can be copied to a second list. Next the cost of each of these ingredients can be fetched from DB 112 (FIG. 1) and the ingredients in the list can be organized according to their cost. The ingredient with the highest cost at the top of the list and the one with the lowest cost at the bottom of the first list.

At block 509 the 1^{st} ingredient from the first list can be obtained and a decision is made 510 whether it can be associated with another ingredient from the first list. The decision can be based on the ratio between the two ingredients that is written in the cell, which is in the junction of the row of the first ingredient and the column of the second ingredient. Cell in which that ratio is zero indicates that the two relevant ingredients cannot be associated. If 510 yes, then the two ingredients can be added 512 to an optional recipe. If 510 no, then a decision is made whether the ingredient from the first list 514 can be associated with ingredient from the second list. If 520 yes, then the two ingredients can be added 512 to an optional recipe. If 520 no, then a decision is made 522 whether there are additional ingredients in the first list.

If 522 there are no additional ingredients, then process 500 may proceed 524 to block 550 in FIG. 5B and present 552 the optional recipe to the chef in order to get his approval. If 560 the recipe is approved then the new AID can be added 564 to the menu of the day as the dish of the day. If 560 the recipe is not approved, the chef may be prompt to amend 562 the recipe and the amended recipe can be added 564 to the menu of the day as the dish of the day and process 500 can be terminated 570. In some example embodiment of the disclosed technique blocks 552 to 560 can be implemented by processing unit 110 FIG. 1 that can be programed to execute those blocks.

If 522 there are additional ingredients in the first list, then the next ingredient in the first list can be fetched and be checked 526 whether it can be associated with another ingredient from the first list and the process can proceed 528 to block 530 in FIG. 5B. If 532 the two ingredients can be associated then the ingredients can be added 542 to the optional recipe. If 532 they cannot be associated, then at block 534 process 500 may combine the first list and the second list into a combined list and check whether 540 two ingredients from the combined list can be associated. If 540 yes, then the ingredients can be added to the optional recipe. If 540 the ingredients cannot be associated then the process proceed 544 and returns to block 522 in FIG. 5A.

It will be appreciated by a person having ordinary skill in the art to modify process 500 in order to handle also ingredients that their popularity score is low (L).

In the description and claims of the present disclosure, each of the verbs, “comprise”, “include”, “have”, and conjugates thereof, are used to indicate that the object or objects of the verb are not necessarily a complete listing of members, components, elements, or parts of the subject or subjects of the verb.

The present disclosure has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Many other ramification and variations are possible within the teaching of the embodiments comprising different combinations of features noted in the described embodiments.

It will be appreciated by persons skilled in the art that the present invention is not limited by what has been particularly shown and described herein above. Rather the scope of the invention is defined by the claims that follow.

We claim:

1. A non-transitory computer readable storage device, of an automated-cooking-restaurant (ACR), comprising executable instructions that when executed cause a processor at an ACR-managing-module (AMM):
i. to obtain a list of leftovers of food ingredients;
ii. to prepare a table TBrr, wherein each cell in the header row comprises the name of a food ingredient from the list of leftovers, its current amount and indication about its popularity and wherein each cell in the header column of TBrr comprises the name of a food ingredient from the list of leftovers, its current amount and indication about its popularity;
iii. to fill in a cell in a junction of row (n) with column (m) recommended ratio between the ingredient that is associated with row (n) and the ingredient that is associated with column (m); and
iv. to analyze the TBrr looking for ingredients that can be associated.
v. to offer an optional recipe for a new dish based on the ingredients that can be associated.

2. The non-transitory computer readable storage device of claim 1, wherein the amount is given in grams.

3. The non-transitory computer readable storage device of claim 1, wherein the list of leftovers of food ingredients is obtained from a Food-Ingredient-Tracker (FIT) module that is configured to track the utilization of the food ingredients.

4. The non-transitory computer readable storage device of claim 1, wherein the recommended ratio is obtained from a database that is associated with the AMM.

5. The non-transitory computer readable storage device of claim 1, wherein the instruction to analyze the TBrr further comprising the instruction to prepare a first list of ingredients that their popularity score is high (H).

6. The non-transitory computer readable storage device of claim 5, wherein the ingredients in the first list are sorted by their cost.

7. The non-transitory computer readable storage device of claim 1, wherein the instruction to analyze the TBrr further comprising the instruction to prepare a second list of ingredients that their popularity score is medium (M).

8. The non-transitory computer readable storage device of claim 7, wherein the ingredients in the second list are sorted by their cost.

9. The non-transitory computer readable storage device of claim 5, wherein the instruction to offer an optional recipe for a new dish is based on at least two ingredients from the first list that can be associated.

10. The non-transitory computer readable storage device of claim 7, wherein the instruction to offer an optional recipe for a new dish is based on at least two ingredients from the second list that can be associated.

11. The non-transitory computer readable storage device of claim 1, wherein the instruction to analyze the TBrr further comprising the instruction to prepare a combined list of ingredients that their popularity score is high (H) or medium (M).

12. The non-transitory computer readable storage device of claim 11, wherein the instruction to offer an optional recipe for a new dish is based on at least two ingredients from the combined list that can be associated.

13. The non-transitory computer readable storage device of claim 1, wherein the instruction to offer an optional recipe for a new dish further comprising the instructions:
i. to present the optional recipe to a chef;
ii. to obtain the chef's amendments;
iii. to generate a recipe for the new dish;
iv. to add the new dish to the menu that is currently used.

14. A system for increasing the efficiency of an automated cooking restaurant (ACR) by offering a new dish, the system comprising:
i. a database that stores a plurality of menus of a plurality of types of restaurants and a plurality of recipes that are related to the plurality of menus, a plurality of food ingredients and recommended ratio between different food ingredients;
ii. a processing module that is configured to offer a new dish can be prepared from a list of leftovers of food ingredients;
iii. a non-transitory computer readable storage device that comprising executable instructions that when executed cause the processing module at an automated cooking restaurant managing module (AMM) to search the database looking for ingredients from the list of leftovers that can be associated. and
iv. a communication module that is configured to communicate with an operator the ACR and with a customer of the ACR.

15. The system of claim 14, wherein the non-transitory computer readable storage device comprising executable instructions that when executed cause the processing module to track the utilization of the food ingredients and to deliver the list of leftovers of food ingredients.

16. The system of claim 14, wherein the types of restaurants includes Italian restaurants.

17. The system of claim 15, wherein the list of leftovers of food ingredients includes the amount of each food ingredient.

18. The system of claim 17, wherein the amount is given in grams.
